(19) United States
(12) Patent Application Publication
(10) Pub. No.: US 2013/0149535 A1
(43) Pub. Date: Jun. 13, 2013

(54) BIODEGRADABLE NANO-, MESO-, AND MICRO-POLYMER PARTICLES FOR MAINTAINING A LOW SURFACE TENSION IN THE LUNG AND FOR PROTECTING THE PULMONARY SURFACTANT

(71) Applicants: Moritz Beck-Broichsitter, Marburg (DE); Thomas Schmehl, Giessen (DE); Tobias Gessler, Wettenberg (DE)

(72) Inventors: Moritz Beck-Broichsitter, Marburg (DE); Thomas Schmehl, Giessen (DE); Tobias Gessler, Wettenberg (DE)

(73) Assignee: Justus-Liebig-Universitat Giessen, Giessen (DE)

(21) Appl. No.: 13/809,626

(22) PCT Filed: Jul. 18, 2011
(86) PCT No.: PCT/DE2011/001471

§ 371 Date: Feb. 14, 2013

(30) Foreign Application Priority Data
Jul. 16, 2010 (EP) EP 10169915

(51) Int. Cl. C08F 220/34

(52) U.S. Cl. CPC C08F 220/34
USPC 428/402; 526/312

(57) ABSTRACT

The present invention provides nano-, meso- and micro-polymer particles which are able to bind pathogenic proteins penetrating into the lining layer of the lung. Known pathogenic proteins in the pulmonary lining layer are negatively charged. These proteins damage the pulmonary surfactant system which is essential to maintain a low surface tension in the lung and thus a functional respiration. Polymer particles of this invention have a diameter between 20 nm and 10 μm, are water-insoluble, have a positive surface charge and a low surface hydrophobicity. The isoelectric point of said particles is greater than 5 to that said particles are present in the lining layer of the lung as positively charged particles, and at the same time higher than the isoelectric point of the pathogenic protein to be bound. Polymer particles of this invention can for example be prepared using the precipitation or emulsion method. Polymer particles of this invention can be utilized for maintaining a low surface tension in the lung and for protecting the pulmonary surfactant.

### BACKGROUND OF THE INVENTION

1. Field of the Invention

The present invention relates to the fields of internal medicine, pharmacology, nanotechnology and medical technology.

2. Brief Description of Related Technology

The alveolar space of mammalian lungs is covered with a complex surfactant system which reduces the surface tension to prevent alveolar collapse during respiration. Pulmonary surfactant is secreted by type II pneumocytes and composed of approximately 90% lipids and 10% proteins. The lipids covering the alveolar surfaces mainly consist of phospholipids (˜80-90%) and to a small extent of neutral lipids (˜10-20%). Among the phospholipids, phosphatidylcholines (˜70-80%) and phosphatidylgycerols are most abundant, while phosphatidylinositols, phosphatidylserines and phosphatidylethanolamines are present in smaller amounts. Roughly half of the protein mass of the alveolar surfactant consists of the surfactant-associated proteins SP-A and SP-D which are both high-molecular hydrophilic proteins, as well as SP-B and SP-C which are low-molecular hydrophobic proteins. Numerous in vitro studies are focused on the complex interaction between phospholipids (phosphatidylcholines and phosphatidylglycerols) and surfactant proteins (SP-B and SP-C) which allow the decrease of the surface tension in the alveolar space to values close to 0 mN/m during compression/expansion cycles. Such extremely low surface tension values can only be achieved with surface films rich in phospholipids. These monolayers furthermore possess a sufficiently high stability and fluidity to allow a replacement of individual surfactant components during a surface change at the air-water interface. Upon compression of the surface film (expiration), SP-B and SP-C promote cleaning of the monolayer, and primarily non-phospholipid compounds are transferred back into the bulk phase (“squeeze out”), thus forming a surface-associated surfactant reservoir. Upon expansion of the alveolar surface (inspiration), SP-B and SP-C facilitate the fast re-entry and redistribution of surfactant lipids present in the surface-associated surfactant reservoir, a process which is essential to limit the increase of the surface tension.

The penetration of plasma proteins (albumin) into the lining layer of the lung influences the pulmonary surfactant function as for example described for the adult respiratory distress syndrome (ARDS) (W. Seeger, C. Grube, A. Günther, R. Schmidt: “Surfactant inhibition by plasma proteins: differential sensitivity of various surfactant preparations”, Eur Respir J 1993, 6:971-977). A disturbed surfactant function is also observed in other pulmonary and cardiac disorders (A. Günther, C. Siebert, R. Schmidt, S. Ziegler, F. Grimminger, M. Yabut, B. Temmesfeld, D. Walmrath, H. Morr, W. Seeger: “Surfactant alterations in severe pneumonia, acute respiratory distress syndrome, and cardiogenic lung edema”, Am J Respir Crit Care Med 1996, 153:176-184; A. Günther, R. Schmidt, F. Nix, M. Yabut-Perez, C. Guth, S. Rosseau, C. Siebert, F. Grimminger, H. Morr, H. G. Velcovsky, W. Seeger: “Surfactant abnormalities in idiopathic pulmonary fibrosis, hypersensitivity pneumonitis and sarcoidosis”, Eur Respir J 1999, 14:565-573). As possible therapeutic strategy for such diseases, the surfactant replacement therapy has already been discussed for years in which synthetic or natural surfactant is introduced into the lung. This therapeutic approach however does not solve the underlying problem, namely the presence of harmful proteins in the lining layer of the lung. Accordingly, also surfactant which is introduced into the lung for therapeutic reasons may equally be impaired or inactivated.

In the past few years, biocompatible polymer particles were investigated with respect to a use as possible drug carrier, also for pulmonary administration. A direct delivery of encapsulated drugs into the lung allows the release of drugs at the desired target site in a sustained and controlled manner, which consequently results in a prolongation of the pharmacological effect. Polymer particle formulations furthermore not only allow a protection of the encapsulated active substance against degradation, but also the targeted addressing of specific sites of action or cell populations in the respiratory system. Meanwhile, a good pulmonary tolerability was demonstrated in a large number of in vitro and in vivo studies for various biodegradable polymer particles.

### SUMMARY OF THE INVENTION

The present invention provides nano-, meso- and micro-polymer particles which possess a positive surface charge and a positive ζ-potential. These particles are able to bind pathogenic proteins which in certain diseases penetrate into the lining layer of the lung and thus influence the biophysical properties of the pulmonary surfactant. By this means, polymer particles of the present invention protect the pulmonary surfactant system.

Surprisingly, nano-, meso- and micro-polymer particles introduced into the lung are able to positively influence the surfactant function, due to an adsorption of plasma proteins which penetrated into the lining layer of the lung on the surface of these particles. Adsorbed plasma proteins are no longer able to interfere with the surfactant structure at the air-water interface.

The results of the present invention demonstrate that the nano-, meso- and micro-polymer particles of this invention are suitable for restoring and maintaining a low surface tension in the lung and for protecting the pulmonary surfactant.

### BRIEF DESCRIPTION OF THE FIGURES

FIG. 1 is a scanning electron microscopic image of Eudragit E100 nano-particles with a mean particle size of approximately 500 nm.

FIG. 2 graphically illustrates the particle size distribution as determined by dynamic light scattering (DLS) for newly prepared Eudragit® E100 nanoparticles with a mean particle size of approximately 500 nm.

FIGS. 3a and 3b provide the adsorption capacity (Γ) of Eudragit E100 nanoparticles with a mean particle size of approximately 500 nm for BSA and cytochrome c after incubation of particles with respective proteins in different concentrations (a) and BSA- and cytochrome c adsorption data fitted to the Langmuir model (b).

### DETAILED DESCRIPTION OF THE INVENTION

Aim of the present invention is to provide agents which are suitable for restoring and maintaining a low surface tension in the lung and for the protection of the pulmonary surfactant.

The aim to provide agents which are suitable for restoring and maintaining a low surface tension in the lung and for the protection of the pulmonary surfactant is solved according to the present invention by biocompatible nano-, meso- and micro-polymer particles to bind pathogenic proteins which penetrate into the lining layer of the lung, characterized in that said particles
have a diameter between 20 nm and 10 μm,
are water-insoluble,
have a positive surface charge,
have a low surface hydrophobicity, equivalent to a contact angle of less than 120°, which is determined according to the sessile drop method,
an isoelectric point which is greater than 5 so that said particles are present as positively charged particles under physiological conditions in the lung, which is at the same time higher than the isoelectric point of the pathogenic protein to be bound, and
possess a positive ζ-potential above +20 mV.

Surprisingly it was found that biocompatible nano-, meso- and micro-polymer particles with these features are able to maintain a low surface tension in the lung and to protect the pulmonary surfactant by binding to pathogenic proteins which penetrate into the lining layer of the lung. The lining layer of the lung is also referred to as the pulmonary liquid layer.

In the following, the inventive and biocompatible nano-, meso- and micro-polymer particles are referred to in brief as “polymer particles”.

The naturally occurring surfactant proteins SP-B and SP-C are comparably small proteins with a molecular weight ≦10 kDa. They are very hydrophobic and possess an isoelectric point (IEP) of approximately 10-12, which means than these proteins are positively charged under physiological conditions.

On the contrary, known pathogenic proteins like e.g. pathogenic plasma proteins are significantly larger and thus possess a considerably higher molecular weight (MW). In contrast to the surfactant proteins SP-B and SP-C, these proteins have an IEP of less than 8 and are consequently negatively charged under physiological conditions. These pathogenic proteins are furthermore substantially less hydrophobic than natural surfactant proteins. Examples for physiologically relevant pathogenic proteins are albumin (IEP: approx. 4.6; MW approx. 66 kDa), fibrinogen (IEP: approx. 5.8; MW: approx. 340 kDa) and hemoglobin (IEP: approx. 7.1; MW: approx. 64 kDa). Isoelectric points and molecular weights of pathogenic proteins occurring in the lung are known to the expert in this field.

Pathogenic proteins penetrate into the lining layer of the lung, disturb the physiological interactions of natural surfactant proteins with phospholipids and thus lead to an increased surface tension in the lung.

Polymer particles of the present invention have an isoelectric point (IEP) greater than 5 and are thus present as positively charged particles in the lung under physiological conditions. In a preferred embodiment, polymer particles of the present invention possess an isoelectric point greater than 7. In a particularly preferred embodiment, polymer particles of the present invention possess an isoelectric point greater than 9. The isoelectric point of polymer particles of the present invention furthermore has to be chosen such that it is higher than the IEP of the pathogenic protein to be bound. Those skilled in the art know how to determine the isoelectric point of polymers, for example using polyelectrolyte titration. The expert may use this knowledge without leaving the scope of protection of the patent claims.

Polymer particles of the present invention can optionally be permanently positively charged, which is for example the case if these contain polymers with quaternary nitrogen atoms.

Polymer particles of the present invention have a diameter between 20 nm and 10 μm. Particles with a diameter of at least 200 nm are actively recognized by macrophages in the lung, internalized and subsequently digested. Pulmonary macrophages represent an efficient clearance mechanism of the deeper lung (respirable bronchial tubes, alveolar space). Nanoparticles which are smaller than 200 nm are removed by unspecific mechanisms (passive transport, diffusion, endocytosis, transcytosis and the like) from the lining layer of the deeper lung into epithelial cells, macrophages, immune defence cells, dendritic cells, endothelial cells or into the interstitium. Polymer particles of the present invention may however not be larger than 10 μm since the macrophages of the lung are not able to efficiently internalize and digest bigger particles. In a preferred embodiment, polymer particles of the present invention have a diameter between 200 nm and 10 μm. In a particularly preferred embodiment, polymer particles of the present invention have a diameter between 200 nm and 6 μm.

The polymer particles of the present invention are water-insoluble. Within the sense of the present invention, water-insoluble polymers are understood to mean polymers whose solubility in water is less than 0.1 percent per weight.

Polymer particles of the present invention possess a positive surface charge and a positive ζ-potential above +20 mV, which allows an adsorption of pathogenic proteins due to electrostatic interaction while natural surfactant proteins are not adsorbed. In a preferred embodiment, polymer particles of the present invention have a positive surface charge and a positive ζ-potential above +40 mV. In a particularly preferred embodiment, polymer particles of the present invention have a positive surface charge and a positive ζ-potential above +60 mV. The particles with a positive surface charge are cationic particles.

Adsorption of the rather hydrophilic pathogenic proteins is in addition supported by the low surface hydrophobicity of polymer particles of this invention, while the hydrophobic surfactant proteins are not adsorbed. According to the invention, “low surface hydrophobicity” is understood to mean that the contact angle as determined by the sessile drop method is lower than 120° degrees. In a preferred embodiment, polymer particles of this invention possess a surface hydrophobicity such that the contact angle as determined by the sessile drop method is lower than 90° degrees. In a particularly preferred embodiment, polymer particles of this invention possess a surface hydrophobicity such that the contact angle as determined by the sessile drop method is lower than 60° degrees.

Evident is that the adsorption of pathogenic proteins caused by polymer particles of this invention is due to solely physical interactive processes between particles and proteins. It is obvious to the expert in this field that all particles which possess the characteristics of claim 1 are suitable for adsorbing pathogenic proteins in the lining layer of the lung.

Suitable monomers to be used for the preparation of polymer particles of this invention are for example, but not limited to, acrylates, methacrylates, butyl methacrylates, (2-dimethylaminoethyl)-methacrylate, amines, amides, acetales, polyester, ketales, anhydrides and saccharides. These may be present either in the form of a homopolymer, copolymer, block polymer, graft copolymer, star polymer, comb polymer, highly branched polymer, statistic polymer or a dendrimer.

Polymer particles of the present invention possess a positive surface charge. This means that either the polymer itself carries positive charges (e.g. cationic acrylates, cationic comb polymers) and is processed to yield said particles utilizing a generally known preparation procedure (e.g. nanoprecipitation, emulsion method). Furthermore, polymers can be utilized which are either uncharged or carry negative charges and are processed to yield said particles utilizing a generally known preparation procedure (e.g. nanoprecipitation, emulsion method). The positive charge of particles is generated by the presence of cationic emulsifiers (e.g. cetylpyridinium chloride) during the preparation procedure. Particles can furthermore be equipped with a positive surface charge after preparation by adding further steps (coating with positively charged coating substances like chitosan, DEAE-dextran, DEA-PA, DEAPA-PVA, PEI). DEAE thereby stands for a diethylaminoethyl group, DEA-PA for diethylamino-polyamide, DEAPA-PVA for diethylaminopropylamine-modified polyvinyl alcohol and PEI for polyethyleneimine.

In a preferred embodiment, polymer particles of this invention are composed of poly-(butyl methacrylate)-co-(2-dimethylaminoethyl)-methacrylat-co-methyl methacrylate. This terpolymer is known to those skilled in the art and may be used within the scope of the present invention for the preparation of the inventive polymer particles. The ratio of the three monomer species butyl methacrylate, 2-(dimethylaminoethyl)-methacrylate and methyl methacrylate may vary according to this invention, as long as the resulting particles possess the characteristics of claim 1. The expert in the field knows how to determine which terpolymer composition fulfills these requirements and is thus able to identify suitable terpolymers without much effort and without leaving the scope of protection of the patent claims.

In a particularly preferred embodiment, butyl methacrylate, 2-(dimethylaminoethyl)-methacrylate and methyl methacrylate are present in a ratio of 1:2:1 (w/w/w). Such a terpolymer is known under the name of Eudragit® E100. Polymer particles of this invention which are prepared from such a polymer may then be characterized in that their isoelectric point is between 8 and 9. Their contact angle is between 80 and 90°, for example 86°. Furthermore, their ζ-potential is positive and above +20 mV, namely for example between +40 and +60 mV. The diameter of such particles is advantageously higher than 200 nm, ranging for example between 400 and 500 nm. Particles may thus be actively phagocytized by alveolar macrophages and removed from the lining layer of the lower respiratory tract. It is furthermore possible to administer said particles by inhalation to the lung.

Polymer particles of the present invention may for example be prepared by nanoprecipitation or using the emulsion method. Nanoparticles may furthermore be prepared by salting out or by polymerization, and microparticles may be prepared using spray drying.

If said particles are manufactured by nanoprecipitation, a 0.1 to 10% solution (w/v) of the polymer is prepared in a first, polar aprotic solvent and subsequently precipitated in a second solvent. The first solvent has to dissolve the polymer in this procedure and to be completely or partly miscible with the second solvent, whereby the second solvent does not dissolve the polymer. Suitable polar aprotic solvents are for example acetone, acetonitrile, tetrahydrofuran, dimethylsulfoxide, trichloromethane and ethyleneamine. Advantageously, water is used as second solvent.

Precipitation can be performed by addition of the polymer solution to the second solvent or by dialysis against this solvent. The organic solvent is subsequently removed and the particles are obtained in suspension.

The choice of the first solvent thereby depends on the preparation procedure. Generally such solvents are suitable as first solvent which dissolve the polymer and are completely or partly miscible with the second solvent. Defined diameters of inventive polymer particles as well as a narrow size distribution can be adjusted accordingly by the choice of the preparation procedure, the polymer concentration in the organic phase, stirring speed, mixing speed and the volume ratios. Furthermore, a surfactant may optionally be added to the polymer solution, for example an anionic or non-ionic surfactant. Addition of a surfactant also allows to adjust the diameter of inventive polymer particles as well as the size distribution in a defined manner. The aforementioned methods to adjust diameter and size distribution are known to the expert in this field and may be applied without leaving the scope of protection of the patent claims.

It becomes obvious that an advantage of the present invention is to provide a preparation procedure for polymer particles, including the steps:
a) Dissolving of the polymer in a first, organic, preferably polar aprotic solvent.
b) Precipitation of particles by addition of the polymer solution to a second solvent or by dialysis against this second solvent, whereby first and second solvent are completely or partly miscible, but the second solvent is not able to dissolve the polymer.
c) Removal of the first solvents and obtaining the particles in suspension.

In this context it is advantageous if in step a) 1 to 40 mg, preferably 10 to 30 mg of polymer is dissolved per ml of solvent. Furthermore preferred is if the polymer in step a) is a homopolymer, copolymer, block polymer, graft copolymer, star polymer, comb polymer, highly branched polymer, statistic polymer or dendrimer whose monomer units are chosen from acrylates, methacrylates, butyl methacrylates, (2-dimethylaminoethyl)-methacrylates, amines, amides, acetales, polyester, ketales, anhydrides and saccharides, and if the first solvent is chosen from acetone, acetonitrile, tetrahydrofuran, dimethylsulfoxide, trichloromethane and ethyleneamine, and if the second solvent is completely or partly miscible with the first solvent and does not dissolve the polymer.

Particularly advantageous is if in step a) 20 mg of polymer is dissolved per ml of solvent. The polymer poly-(butyl methacrylate)-co-(2-dimethylaminoethyl)-methacrylate-co-methyl methacrylate may have a butyl methacrylate, 2-(dimethylaminoethyl)-methacrylate and methyl methacrylate ratio of 1:2:1 (w/w/w), the first solvent may be acetone and the second solvent water.

Polymer particles of the present invention are preferably nebulizable with piezo-electric, jet, ultrasonic aerosol generators, soft-mist-inhalers, metered dose inhalers or dry powder inhalers, which means that administration to the lung is performed by inhalation of an aerosol (suspension, powder) using a nebulizer. Advantageous for these applications is if the diameter of the inventive polymer particles is lower than 6 μm in order to be able to reach the depth of the lung.

A further route of administration to the lung is instillation, for example using a catheter, a bronchoscope or a respiratory therapy device (e.g. tube or tracheal cannula).

Polymer particles of this invention can be utilized for the manufacture of a pharmaceutical agent suitable to prevent and/or treat lung diseases which are associated with an increased surface tension in the lung and damage of the pulmonary surfactant. Polymer particles of this invention serve to restore and to maintain a low surface tension in the lung and to protect the pulmonary surfactant.

Polymer particles of this invention can thus be utilized for the manufacture of pharmaceutical agents for the treatment or diagnosis of the following diseases: neonatal respiratory distress syndrome, acute/adult respiratory distress syndrome (ARDS), acute lung injury (ALI), lung infections, pneumonia, pulmonary hypertension, cardiogenic pulmonary oedema, asthma, chronic obstructive pulmonary disease (COPD)/emphysema, interstitial lung diseases, lung tumors, toxic alveolitis, alveolar hemorrhagic syndrome, cystic fibrosis, idiopathic pulmonary hemosiderosis, collagen diseases, vasculitides, pneumoconioses, pulmonary eosinophilic infiltrates, radiation damage, hereditary or congenital lung diseases.

The effect of polymer particles of this invention is thereby of a purely physical nature and based on the above described adsorption of pathogenic proteins. Polymer particles loaded with pathogenic proteins are subsequently eliminated by lung macrophages or removed from the pulmonary lining layer due to unspecific clearance mechanisms.

### Embodiments

Further characteristics, details and advantages of the invention derive from the wording of the claims as well as from the following description of exemplary embodiments on the basis of added figures. These figures show:

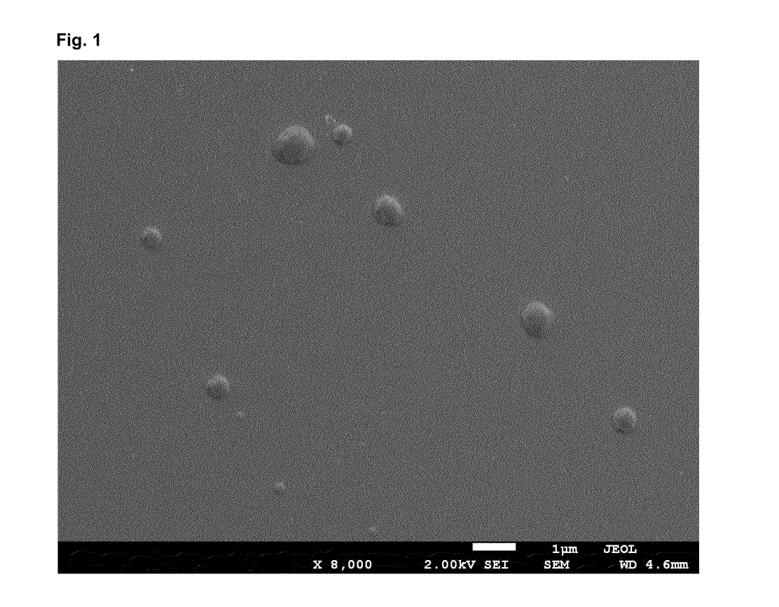

FIG. 1 Scanning electron microscopic image of Eudragit E100 nanoparticles with a mean particle size of approximately 500 nm

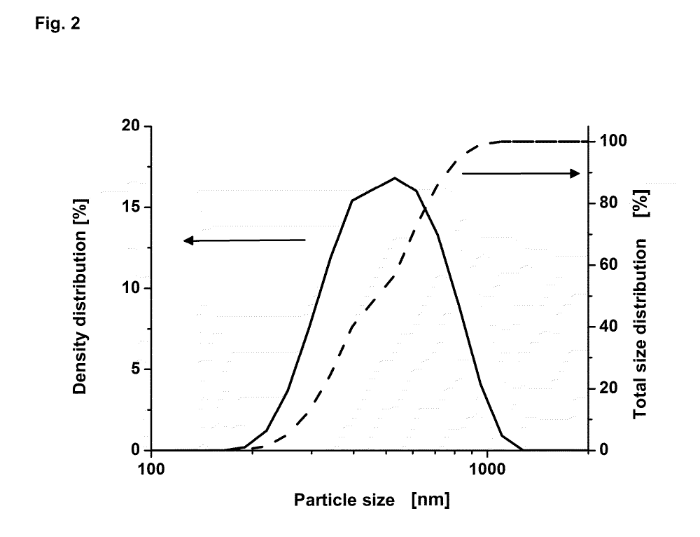

FIG. 2 Graphs demonstrating the particle size distribution as determined by dynamic light scattering (DLS) for newly prepared Eudragit® E100 nanoparticles with a mean particle size of approximately 500 nm. The solid line represents the particle size density distribution, the dashed line the cumulative particle size distribution.

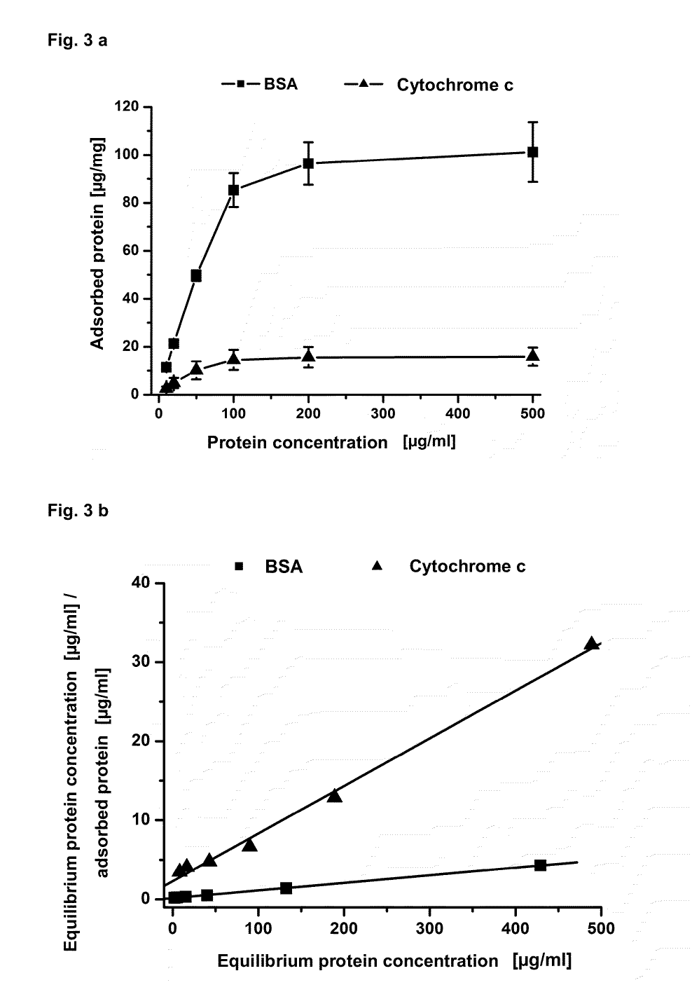

FIG. 3a, b Adsorption capacity (Γ) of Eudragit E100 nanoparticles with a mean particle size of approximately 500 nm for BSA and cytochrome c after incubation of particles with respective proteins in different concentrations (a) and BSA- and cytochrome c adsorption data fitted to the Langmuir model (b). Solid lines in (b) represent the lines of best fit for measured data. Values in (a) are represented as mean value±standard deviation (n=3).

Materials

The embodiment example described in the following used cationic polymer, namely poly(butyl methacrylate)-co-(2-dimethylaminoethyl)-methacrylate-co-methyl methacrylate) 1:2:1 (Eudragit® E100) obtained from Roehm (Darmstadt, Germany). Cytochrome c (from bovine heart, 95%) and bovine serum albumin (BSA) was purchased from Sigma-Aldrich (Steinheim, Germany). All other chemicals and solvents used in these experiments were of highest commercially available purity.

Methods

1. Preparation of Nanoparticles

Nanoparticles were prepared following a procedure as described by Hyun-Jeong Jeon, Young-II Jeong, Mi-Kyeong Jang, Young-Hoon Park, Jae-Woon Nah: “Effect of solvent on the preparation of surfactant-free poly(DL-lactide-co-glycolide) nanoparticles and norfloxacin release characteristics”, Int J Pharm 2000, 207:99-108. Within the scope of the present invention, 200 mg of polymer (Eudragit® E100) was dissolved in 10 ml acetone. Subsequently, 10 ml polymer solution was transferred into a dialysis tube (pore size 10 kDa) and dialyzed for 24 h against aqua dest. Particles were characterized and used immediately after their preparation.

Characterization of Nanoparticles

Nanoparticles prepared as outlined in under Methods, point 1, were characterized using procedures as described in the following under point 2 to 4.

2. Scanning Electron Microscopy (SEM)

One drop of the diluted nanoparticle suspension was applied onto a silicon wafer. Subsequently, all samples were vacuum-dried and coated with platinum using a Gatan Alto 2500 Sputter Coaters (Gatan GmbH, Munich, Germany). The morphology of nanoparticles was investigated at 2-5 kV using a scanning electron microscope (JSM-7500F, JEOL, Eching, Germany).

3. Determination of Size and ζ-Potential

Hydrodynamic diameter and size distribution of obtained nanoparticles was determined by dynamic light scattering (DLS). The ζ-potential was measured by laser Doppler anemometry (LDA) using a zetasizer NanoZS/ZEN3600 (Malvern Instruments, Herrenberg, Germany). All experiments were carried out at a temperature of 25° C. and with samples in suitable dilution. For the DLS, samples were diluted with filtrated and double-distilled water; samples for LDA were diluted in 1.56 mM NaCl. All measurements were performed in triplicates and immediately after preparation of the nanoparticles with at least 10 runs.

4. Adsorption of Proteins to Nanoparticles

In order to measure the adsorption of cytochrome c and BSA to nanoparticles, nanoparticle suspensions of defined concentrations were incubated with defined amounts of the model protein cytochrome c (IEP=10, MW=12.3 kDa) and the pathogenic model protein BSA (IEP=approx. 4.6, MW=approx. 66 kDa) for 3 h at 25° C. The amount of protein adsorbed to nanoparticles was calculated as the difference between the amount of protein added to the nanoparticle suspension and the amount of non-adsorbed protein remaining in the aqueous phase. After incubation, samples were subjected to centrifugation for 2 h at 16 000×g (Centrifuge 5418, Eppendorf, Hamburg, Germany), and the fraction of non-bound protein in the supernatant was measured using the extinction coefficients of cytochrome c and BSA, respectively. For each protein concentration, a control samples without nanoparticles was prepared to determine the protein loss during the incubation time. The degree of protein loading was calculated as follows:

$$Protein loading = \frac{total amount of protein - free protein}{total amount of protein} \cdot 100 [ \% ] .$$

5. Surface Hydrophobicity

The surface hydrophobicity can be determined using the sessile drop method, a method known to the expert in this field for optical contact angle measurements.

6. Isoelectric Point

The isoelectric point of polymer particles can be determined using polyelectrolyte titration.

Results

1. Characteristics of Nanoparticles

The physicochemical characteristics of nanoparticles which were determined according to the section “Methods, point 3” are listed in Table 1.

TABLE 1
Characteristics of nanoparticle formulations prepared
according to “Methods, point 1”

| Nanoparticle | Size | | ξ-Potential |
|---|---|---|---|
| formulation | [nm]¹ | PDI¹ | [mV] |
| Eudragit ® E100 | 486 | 0.070 | +53.7 |

¹: Values were determined by dynamic light scattering (DLS).
PDI: Polydispersity index

In order to determine the structure, size and size distribution of the nanoparticle formulation utilized, scanning electron microscopy (SEM) measurements were performed. FIG. 1 shows that the nanoparticles possess a mean particle size of approximately 500 nm. As indicated, the length of the white scale bar corresponds to 1 μm. The majority of particles shown here have a diameter corresponding to approximately half of the length of the scale bar. The image was taken with 8000fold magnification and a voltage 2.0 kV. Nanoparticles showed a more or less spherical shape. Size and size distribution of the nanoparticle formulation were determined by dynamic light scattering (DLS). Typical density curves and total particle size distribution according to DLS are shown in FIG. 2. The solid line represents the density distribution whose scale is indicated on the left y-axis. The dashed line represents the total particle size distribution whose scale is indicated on the right y-axis. It is obvious that the maximum of the density distribution lies around a size of approximately 500 nm. The graphs shown in FIG. 2 thus confirm for all formulations a mean size of about 500 nm with narrow size distributions. Data obtained by scanning electron microscopy measurements (SEM) thus agree well with data obtained by dynamic light scattering (DLS).

The surface charge (ζ-potential) of Eudragit E100 nanoparticles was determined using laser Doppler anemometry, the ζ-potential was +53.7 mV and is thus positive.

The isoelectric point of the particles is 8.5±0.5, the contact angle is 86°.

2. Adsorption of Cytochrome c and BSA to Nanoparticles

To simulate the adsorption of surfactant-associated proteins on the surface of different nanoparticles formulations, the positively charged model protein cytochrome c was used (FIG. 3). BSA was chosen as model protein for a pathogenic protein in the lining layer. As shown in the adsorption isotherms in FIG. 3a in which the absorbed amount (Γ) of cytochrome c and BSA, respectively, is plotted as a function of the concentration (c₀) of cytochrome c or BSA, respectively, values of up to ˜15 μg/mg polymer (n=3) were obtained for the amount of cytochrome c adsorbed to the surface of the nanoparticles, and up to ˜100 μg/mg polymer (n=3) in the case of BSA. Adsorption data were subsequently fitted to the Langmuir adsorption model over the entire concentration range as described by the following equation

$$\frac{{c}_{e}}{Γ} = \frac{1}{b \cdot {Γ}_{m}} + \frac{{c}_{e}}{{Γ}_{m}}$$

whereby Γ represents the amount of adsorbed protein, cₑ the equilibrium protein concentration in the incubation medium, b represents a coefficient related to the affinity between nanoparticles and protein, and Γₘ is the maximum adsorption capacity. The lines of best fit are depicted in FIG. 3b, the calculated parameters for the Langmuir equation are given in Tab. 2. These data confirm the formation of a mono-nuclear layer of proteins on the surface of the nanoparticles (R²>0.99). The affinity (b) and thus also the Gibbs free adsorption energy (ΔG⁰) of model proteins to nanoparticle surfaces however was dependent on the kind of protein used. While only a low affinity was observed for the positively charged cytochrome c, (b=0.031±0.012 ml/mg (mean value±S.D., n=3) and ΔG⁰=+1.7±1.5 kJ/mol (mean value±S.D., n=3)), affinity was considerably higher for BSA (b=0.070±0.026 ml/mg (mean value±S.D., n=3) and ΔG⁰=−4.8±0.7 kJ/mol (mean value±S.D., n=3)).

TABLE 2
Langmuir-parameter and free energy for the adsorption of BSA and cytochrome c to na-
noparticles prepared according to “Methods, item 1”

| | Maximum | | | | |
|---|---|---|---|---|---|
| | adsorption | Affinity | | | |
| | capacity Γₘ | constant | | ΔG⁰ | |
| Protein | (μg/mg) | (ml/mg) | Kₐ | (kJ/mol) | R² |
| BSA | 105.9 ± 14,7 | 0.070 ± 0.02 | 7.2 ± 1.9 | −4.8 ± 0.7 | 0.9989 ± 0.0010 |
| Cytochrome | 17.2 ± 3.7 | 0.031 ± 0.01 | 0.6 ± 0.3 | +1.7 ± 1.5 | 0.9948 ± 0.0014 |
| c | | | | | |

Values are indicated as mean values ± standard deviation (S.D.) (n = 3).
Γₘ: maximum adsorption capacity
b: affinity constant of cytochrome c to nanoparticles
Kₐ: equilibrium association constant (Kₐ = Γₘb)
ΔG⁰: Gibbs free energy (ΔG⁰ = −RTInKₐ)

The present invention is not restricted to one of the aforementioned embodiments, but can be varied in many ways.

All features and advantages including design details, spatial arrangements and process steps illustrated in the claims, the description and the figures may be essential to the invention, either independently by themselves as well as combined with one another in any form.

It generally becomes apparent that the knowledge with respect to the interaction mechanisms of the polymer particles with surfactant components and plasma proteins can be used for the targeted production and optimization of colloidal carrier for the therapy of pulmonary diseases.

The adsorption of surfactant-associated proteins on the surface of polymer nanoparticles leads to a deterioration of the pulmonary surfactant function. Adsorbed surfactant proteins are no longer able to organize the structure of the surfactant at the air-water interface and can consequently not reduce the surface tension in a similar manner (with respect to extent and temporal progress) as native surfactant material.

The penetration of plasma proteins (e.g. albumin) into the lining layer of the lung leads to an impaired pulmonary surfactant function, as for example described for the adult respiratory distress syndrome (ARDS) (W. Seeger, C. Grube, A. Günther, R. Schmidt: “Surfactant inhibition by plasma proteins: differential sensitivity of various surfactant preparations”, Eur Respir J 1993, 6:971-977). An adsorption of plasma proteins which penetrated into the lining layer of the lung to the surface of polymer nanoparticles enables the latter to positively influence the pulmonary surfactant function. Adsorbed plasma proteins are no longer able to disturb the structure of the surfactant at the air-water interface.

Biocompatible nano-, meso- and micro-polymer particles of this invention are able to eliminate harmful proteins from the lining layer of the lung without removing the physiologically relevant surfactant-associated proteins. By these means, polymer particles of the present invention protect the pulmonary surfactant system.

1. A biocompatible polymer particle capable of binding pathogenic proteins that penetrate into the lining layer of a mammalian lung, wherein the particle comprises a water insoluble, biocompatible polymer and has:
(a) a diameter between 20 nm and 10 μm,
(b) a positive surface charge,
(c) a low surface hydrophobicity, equivalent to a contact angle of less than 120° as determined according to the sessile drop method,
(d) an isoelectric point greater than 5 and greater than the isoelectric point of the pathogenic proteins to be bound, and
(e) a positive ζ-potential of more than +20 mV.

2. The biocompatible polymer particle of claim 1, wherein the biocompatible polymer is made from monomers selected from the group consisting of acrylates, methacrylates, butyl methacrylates, (2-dimethylaminoethyl)-methacrylates, amines, amides, acetales, polyester, ketales, anhydrides, and saccharides.

3. The biocompatible polymer particle of claim 2, wherein the biocompatible polymer is selected from the group consisting of a homopolymer, copolymer, block polymer, graft copolymer, star polymer, comb polymer, highly branched polymer, statistic polymer, and dendrimer.

4. The biocompatible polymer particle of claim 1, wherein the particle consists of poly-(butylmethacrylate)-co-(2-dimethylaminoethyl)-methacrylate-co-methylmethacrylate.

5. The biocompatible polymer particle of claim 4, wherein the poly-(butylmethacrylate)-co-(2-dimethylaminoethyl)-methacrylate-co-methylmethacrylate is made from a 1:2:1 (w/w/w) ratio of butyl methacrylate, 2-(dimethylaminoethyl)-methacrylate, and methyl methacrylate.

6. The biocompatible polymer particle of claim 1, wherein the diameter is between 200 nm and 10 μm.

7. The biocompatible polymer particle of claim 1, wherein the diameter is between 200 nm and 6 μm.

8. The biocompatible polymer particle of claim 1, wherein the particle is capable of being nebulized by piezo-electric, jet, ultrasonic aerosol generators, soft mist inhalers, metered dose inhalers, or dry powder inhalers.

9. A process for making the biocompatible polymer particle of claim 1, the process comprising:
(a) dissolving the biocompatible polymer in a first organic solvent to form a polymer solution,
(b) adding the polymer solution to a second organic solvent under conditions sufficient to precipitate the polymer particle, wherein the first and second organic solvents are completely or partly miscible with each other, but the second organic solvent is not able to dissolve the polymer particle under the precipitation conditions, and
(c) removing the first organic solvent to obtain the polymer particle in suspension.

10. The process of claim 9, wherein the polymer solution comprises 1 mg to 40 mg of the biocompatible polymer per ml of the first organic solvent.

11. The process of claim 9, wherein:
the biocompatible polymer is a homopolymer, copolymer, block polymer, graft copolymer, star polymer, comb polymer, highly branched polymer, statistic polymer, or dendrimer whose monomer units are selected from the group consisting of acrylates, methacrylates, butyl methacrylates, (2-dimethylaminoethyl)-methacrylates, amines, amides, acetales, polyester, ketales, anhydrides, and saccharides, and
the first organic solvent is selected from the group consisting of acetone, acetonitrile, tetrahydrofuran, dimethylsulfoxide, trichloromethan, and ethylenamine.

12. The process of claim 9, wherein the polymer solution comprises 200 mg of the biocompatible polymer per 10 ml of the first organic solvent.

13. The process of claim 9, wherein:
the biocompatible polymer comprises a poly-(butyl methacrylate)-co-(2-dimethylaminoethyl)-methacrylate-co-methylmethacrylate made from a 1:2:1 (w/w/w) ratio of butyl methacrylate, 2-(dimethylaminoethyl)-methacrylate, and methyl methacrylate,
the first organic solvent is acetone, and
the organic second solvent is water.

14. (canceled)

15. (canceled)

16. The process of claim 9, wherein the first organic solvent is a polar aprotic solvent.

17. The process of claim 9, wherein the polymer solution comprises 10 mg to 30 mg of the biocompatible polymer per ml of the first organic solvent.

18. A process for making the biocompatible polymer particle of claim 1, the process comprising:
(a) dissolving the biocompatible polymer in a first organic solvent to form a polymer solution;
(b) dialyzing the polymer solution against a second organic solvent under conditions sufficient to precipitate the polymer particle, wherein the first and second organic solvents are completely or partly miscible with each other, but the second organic solvent is not able to dissolve the polymer particle under the precipitation conditions; and,
(c) removing the first organic solvent to obtain the polymer particle in suspension.
